(19) United States
(12) Patent Application Publication
(10) Pub. No.: US 2011/0047027 A1
(43) Pub. Date: Feb. 24, 2011

(54) SYSTEM AND METHOD FOR DETERMINING WHETHER AN AD IS UBIQUITOUS

(75) Inventors: Ankur K. GUPTA, Sunnyvale, CA (US); Arun Kumar GNANAMANI, Mountain View, CA (US)

Correspondence Address: FIALA & WEAVER P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/545,342

(22) Filed: Aug. 21, 2009

(51) Int. Cl. G06Q 30/00; G06F 17/30

(52) U.S. Cl. 705/14.52; 707/E17.014

(57) ABSTRACT

A method of determining whether an advertisement will be served against a search query calculates the ubiquitous index of the advertisement and if at least the ubiquitous index is below a predefined threshold, the advertisement is served. The ubiquitous index may be based, at least in part, on either the relatedness of a set of search queries against which the advertisement was served over a predetermined period, or a comparison between a click-through rate associated with the advertisement over the predetermined period and an aggregated click-through rate calculated over a set of advertisements available to be served over the predetermined period, or some combination thereof.

### BACKGROUND

1. Field of the Invention

Aspects of the present invention relate generally to a method for determining the ubiquitous nature of an advertisement used in a sponsored search scenario.

2. Description of Related Art

As is known in the art, auctions or other methods commonly are used to sell Internet advertising spots against search engine queries. When a user enters a search query in a search engine, the search engine generally returns both query results and sponsored search results (i.e., advertisements intended to be relevant to the query). Advertisers generally target their ads based on keywords, phrases, and combinations thereof. When a user selects (or “clicks on”) a sponsored search result, a browser or other application software is redirected to the advertiser's web page, and the advertiser pays the search engine a fee for the referral.

Because the number of ads that the search engine can show to a user is limited, and because different positions on the search results page have different impacts for advertisers (e.g., if two ads are shown together—one above the other—the top ad usually is more likely to be clicked on, etc.), there should exist a system for allocating the positions to advertisers, and auctions have worked well to solve this problem. However, in an effort to have its ads shown to the largest number of users, sometimes an advertiser will purchase ads against search terms that are not necessarily relevant to the product or service being sold.

Thus, it may be desirable in some instances to determine which advertisements are most irrelevant to a given search query, and to use this information to affect the relative weightings or rankings of multiple ads, or to suppress them from being shown at all.

### SUMMARY

Embodiments of the present invention overcome the above-mentioned and various other shortcomings of conventional technology, providing a sponsored search system that may more accurately determine which advertisements should be shown against a particular search query.

### BRIEF DESCRIPTION OF THE DRAWING FIGURES

FIG. 1 is a simplified functional block diagram illustrating the general architecture of the invention according to an embodiment.

FIG. 2 is a logical flowchart of the general process by which a ubiquitous index may be generated according to an embodiment.

FIGS. 3 and 4 illustrate generally the differences between the graphs of a likely ubiquitous ad and a likely non-ubiquitous ad according to an embodiment.

FIG. 5 is a logical flowchart of the general process by which a ubiquitous index may be generated according to an embodiment.

FIG. 6 illustrates generally the correlation between ubiquitous index values and the values of

$$\frac{ctr ( a )}{\vert ctr \vert}$$

and imps(a) according to an embodiment.

### DETAILED DESCRIPTION

Detailed descriptions of one or more embodiments of the invention follow, examples of which may be graphically illustrated in the drawings. Each example and embodiment is provided by way of explanation of the invention, and is not meant to be construed as a limitation of the claimed subject matter. For example, features described as part of one embodiment may be utilized with another embodiment to yield still a further embodiment. It is intended that the appended claims be interpreted broadly to include these and other modifications and variations.

Aspects of the present invention are described below in the context of more accurately determining whether an advertisement is ubiquitous, and determining whether and where to display the ad based on its estimated ubiquity.

Throughout this disclosure, reference is made to “search infrastructure,” which is used to denote a system through which an Internet advertising network operates (e.g., Yahoo's® Publisher Network, etc.). There currently are numerous search infrastructures (e.g., those run by Yahoo!®, Google™, etc.) and most offer similar services, such as, for example, the serving of advertisements; “serving,” as understood in the art, is the mechanism by which advertisements are delivered to web pages, in connection with which they ultimately are displayed. The search infrastructure may comprise a search engine, which may display search results together with possibly relevant advertisements bought against the search query (“sponsored listings”).

Throughout this disclosure, a “query” denotes a search query provided by a user when performing a search via a search engine. It will be understood that a query comprises terms (or keywords), and may contain a single term, multiple terms, a phrase of terms, etc., and that, for purposes of this disclosure, permutations and combinations of multiple terms and phrases are not critical.

In pay-per-click search advertising arrangements, there generally are three main parties involved, namely users (i.e., those searching for something), advertisers (i.e., those purchasing sponsored listings, also known as ads) and the ad auction company (i.e., the entity who ultimately decides which ads will appear next to which search results). Each of these three main parties has different interests and objectives, all of which need to be balanced to maintain a competitive ecosystem.

At a high level, users generally want their search results to be returned to them in the least possible amount of time and to require the least amount of effort, while generally having a pleasurable experience. Advertisers generally want to target users who are most likely to buy their products and/or services. The ad auction company wants to connect the right set of advertisers with the right user and/or search query, while maintaining various checks and balances to ensure the viability and stability of the ecosystem.

Within this framework, advertisers sometimes try aggressively to market their products/services by creating sponsored listings in such a way that they will be selected to be displayed for a large number of users, notwithstanding the users' search queries or their intentions to buy the products/services. Such a practice can introduce two major negative effects on the ecosystem: 1) users are more likely to be shown non-relevant ads, which may result in a bad user experience and potentially could turn the user away from the particular search system entirely; and 2) non-relevant ads may cause relevant ads to be given a lower rank or position on the page than they otherwise might merit, or may cause some relevant ads to not be displayed at all, either of which may cause advertisers to move to another ad auction company that can provide better marketing opportunities.

In light of these concerns, it may be helpful to all parties involved more accurately to determine which advertisements are ubiquitous; i.e., sponsored listings that get displayed for an unusually large number of user searches without having much relevance to the user's query or intention. By more accurately detecting the ubiquitous nature of a sponsored listing, a more consistent and relevant user experience may be provided to the user, while maintaining marketplace health and a good advertiser return-on-investment.

To make possible this more accurate determination of an ad's ubiquity, a “ubiquitous index” (UI) may be generated for each sponsored listing, based on search query and/or impression and/or click logs. UIs may be normalized across all sponsored listings or some segment thereof, which normalized score may facilitate the sponsored search module to make two runtime decisions: 1) whether to allow a sponsored listing to be shown for a given query; and 2) if the sponsored listing is to be shown, the rank of the sponsored listing.

In an embodiment, a UI threshold may be defined. For example, through experimentation and observation it may be discovered that a certain UI threshold is too high (i.e., too many likely non-relevant ads are being served), in which case the UI threshold may be decreased. Further, the UI thresholds may be different as between the decision as to whether an ad will be served at all and the decision as to what rank that ad may receive, which thresholds may depend on other factors used to inform the two decisions.

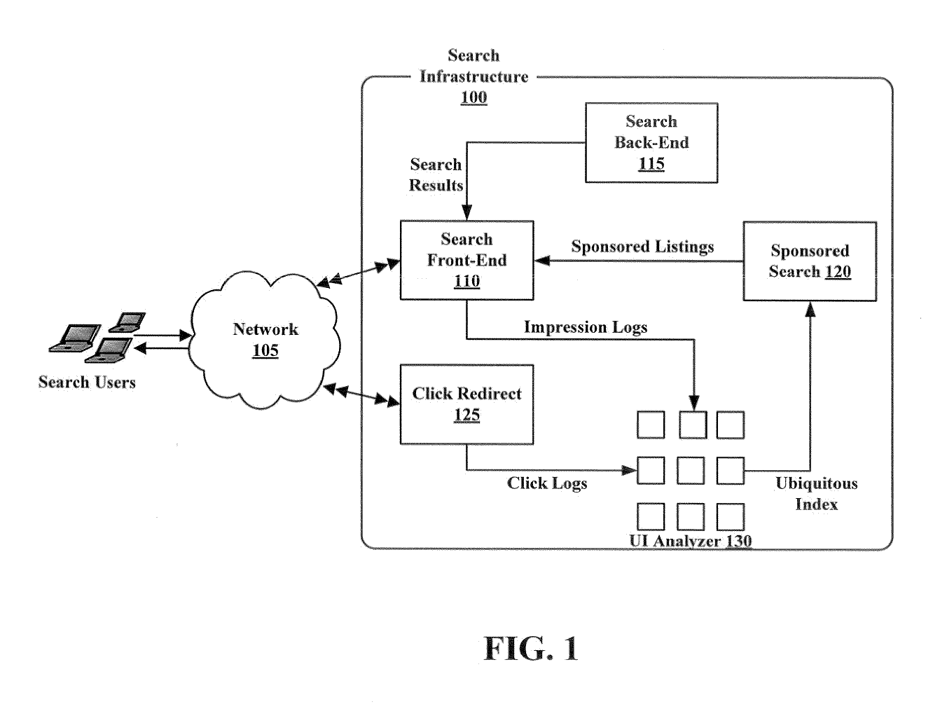

FIG. 1 is a simplified functional block diagram illustrating the general architecture of an embodiment of the invention. Search infrastructure 100 may comprise an Internet advertising network (as described above) and may include any of a number of servers, databases, etc. required for its operation. Search front-end module 110 may respond to user queries by requesting search results from search back-end module 115 and sponsored listings from sponsored search module 120. Click redirect module 125 may redirect users to their final destinations (i.e., the sites to which the search results or sponsored listings point). UI analyzer 130 may analyze impression and click logs (which may contain impression and click counts for both search results and sponsored listings, together with the user queries that caused the search results and ads to be displayed) to produce a ubiquitous index for each sponsored listing. It will be appreciated that this analysis generally will not be done in real-time, but rather “offline” (i.e., the analysis generally will occur on a rolling basis in the background, and not just when a query is received, a new advertisement is added to the system, etc.) The UIs may be sent to the sponsored search module 120 where they may be used to inform runtime decisions regarding a particular sponsored listing. The search infrastructure 100 and search users may be linked together through network 105 (e.g., the Internet, etc.), where users may use a computer to interface with search infrastructure 100 to conduct searches and receive results and ads.

It will be appreciated that modules 110,115,120,125, and 130 illustrated in FIG. 1 may be implemented as hardware elements (e.g., application specific integrated circuit (ASIC) components, system on chip (SoC) components, or other dedicated electronic hardware) in some instances; in some applications, such hardware elements may be selectively reprogrammable via firmware instructions or register settings. Alternatively, the modules depicted in FIG. 1 may be wholly or partially embodied in or implemented by software or other instruction sets executable by general purpose hardware components. Further, it is noted that the several components of search infrastructure 100 may be distributed across more than one physical machine (e.g., computer workstation or server).

In an embodiment, impression logs may be used to find the UI of a sponsored listing (i.e., a confidence measure that indicates the likelihood of the sponsored listing being ubiquitous). In this context, an “impression” is an indication that an ad has been served and displayed to a user. The methodologies disclosed herein may capitalize on the fact that ubiquitous ads generally are displayed for large numbers of related and unrelated searches, whereas targeted ads generally will show up for a relatively smaller number of related searches.

One way to determine if search queries are related to each other is by looking at the number of sponsored listings and search results that appeared in commonality for some or all of those search queries. Generally, the greater the number of results that appear in common with two or more search queries, and the greater the number of search queries for which there are more than one common result, the greater the likely relatedness between the search queries. Thus, by analyzing this commonality, relatedness of the search queries can be estimated, and given that a ubiquitous sponsored listing will be shown for many unrelated searches, the commonality of results can be used to find the ubiquitous nature of an ad (i.e., its UI).

In an embodiment, the UI of an ad may be determined via the following equation, which takes into account the relatedness discussed above:

$$UI ( a ) = [ 1 - \{ \frac{Area ( ads )}{\vert Q ( a ) \vert \cdot \vert NSA \vert} \} ] + [ 1 - \{ \frac{Area ( search\_results )}{( \vert Q ( a ) \vert \cdot \vert NSW \vert )} \} ] \qquad ( 1 )$$

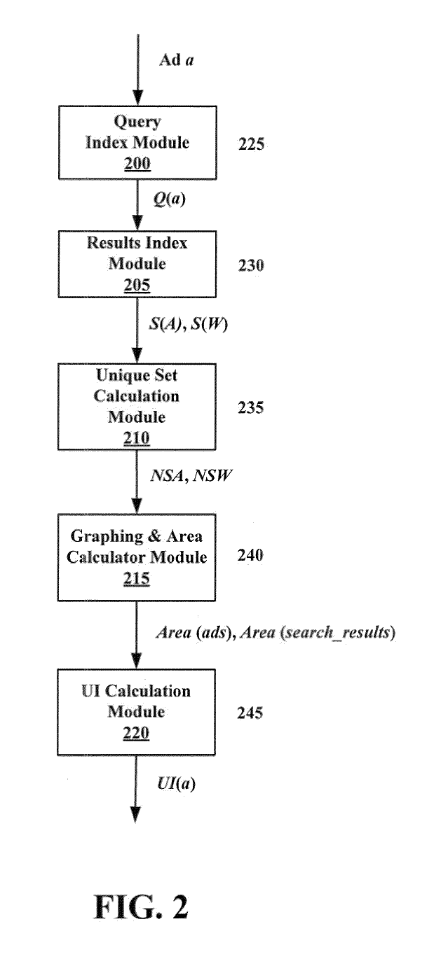

Equation (1) may be implemented as illustrated in FIG. 2. It will be appreciated that each module referenced in the following discussion of FIG. 2 may be implemented in either software or hardware, or some combination thereof, and in practice may be combined with any other module (e.g., the same machine may be used to execute each module's operations).

For each ad, a, displayed for any given query, q, over a predetermined period, t, Q(a) may be determined by query index module 200 at block 225, where Q(a) refers to a set of queries which shared ad, a (i.e., ad, a, was shown for each query in the set), during t. At block 230, for each query, q, in Q(a), A(q) and W(q) may be determined by results index module 205, where A(q) is the set of sponsored listings that were displayed against q during t, and W(q) is the set of search results that were displayed against q during t. W(q) potentially can be very large, and in an embodiment may be limited by considering only the Wₘₐₓ results, where Wₘₐₓ is a scalar value that may be adjusted based on experimentation, observation, or a combination of these and other factors. The union of all A(q) may be calculated by results index module 205 as S(A), which thus contains all the sponsored listings for all the queries against which a was served during t. Next, the union of all W(q) previously obtained may be calculated by results index module 205 as S(W), which thus contains all the search results for all the queries against which a was served during t. At block 235, the unique elements of S(A) and S(W) may be created by unique set calculation module 210 as NSA and NSW, respectively (i.e., there are no duplicate elements among NSA, and no duplicate elements among NSW). At block 240, for each element r in NSA and NSW, freq(r, SA) and freq(r, SW) may be respectively determined by graphing and area calculator module 215, where freq(x, y) refers to the number of times the element x appears in the set y. Next, graphing and area calculator module 215 may plot a graph GA, where points on the x-axis may be based on each element r of NSA, and points on the y-axis may be based on the corresponding freq values. The area bounded between the curve and the x-axis of graph GA may be computed as Area(ads) by graphing and area calculator module 215. Similarly, graphing and area calculator module 215 may plot a graph GW, where points on the x-axis may be based on each element r of NSW, and points on the y-axis may be based on the corresponding freq values. The area bounded between the curve and the x-axis of graph GW may be computed as Area(search_results) by graphing and area calculator module 215. Finally, at block 245, UI calculation module 220 may calculate the UI of ad a as per equation (1).

When search queries are closely related (e.g., “bike” and “bikes,” or “hotels in sf” and “hotels in san francisco”) Area(ads) may be close to |Q(a)|·|NSA|, and when all search queries are the same, all of the queries may yield the same results, thus Area(ads) may be equal to |Q(a)|·|NSA|, and so

$$1 - \{ \frac{Area ( ads )}{\vert Q ( a ) \vert \cdot \vert NSA \vert} \}$$

may be equal to 0. Similarly, in this instance

$$1 - \{ \frac{Area ( search\_results )}{( \vert Q ( a ) \vert \cdot \vert NSW \vert )} \}$$

may be equal to 0; thus, the UI of the ad may be 0, or rather the confidence of the ad being ubiquitous may be 0.

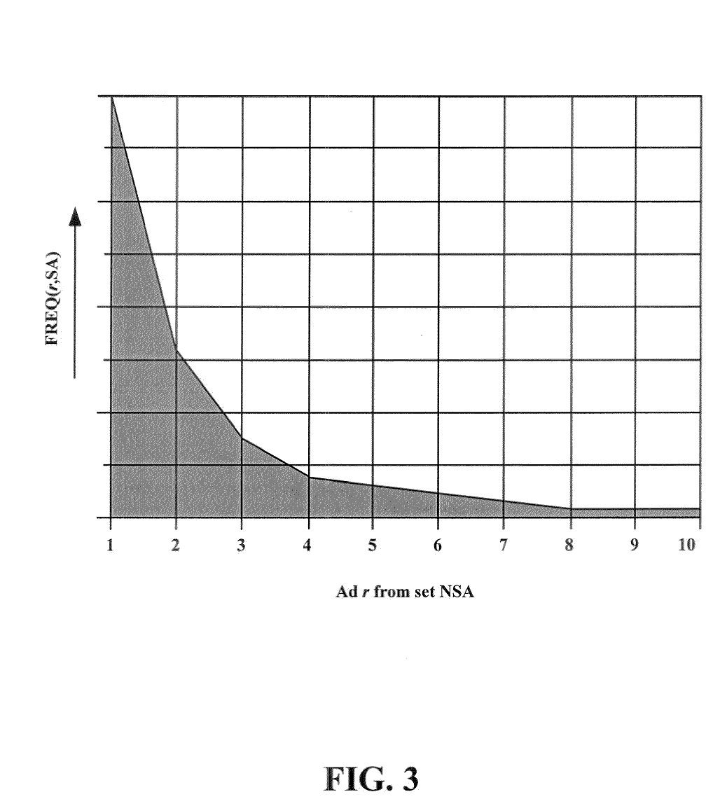

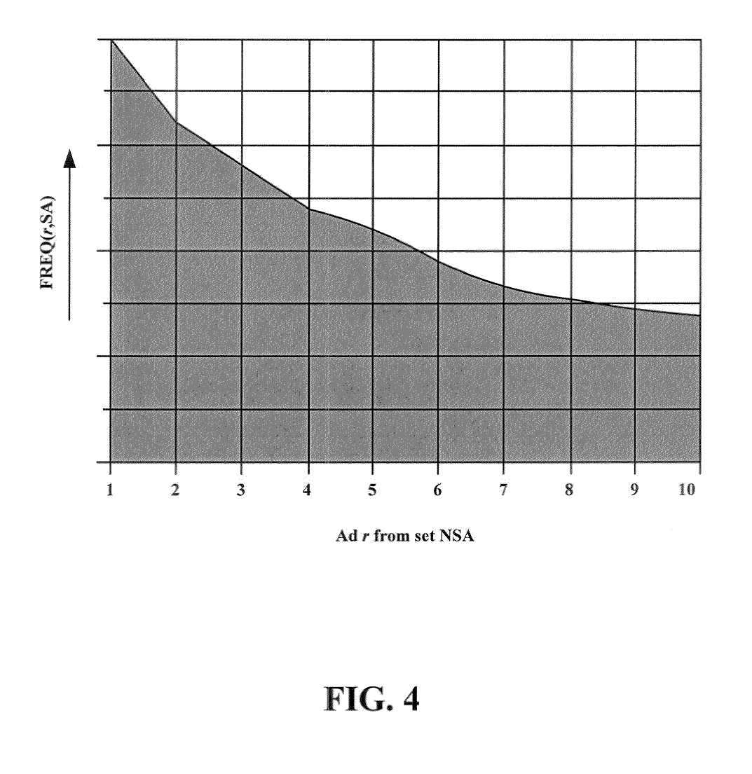

FIGS. 3 and 4 illustrate generally the differences between the graphs of a likely ubiquitous ad (FIG. 3) and an ad that likely is not ubiquitous (FIG. 4). Generally, the smaller the bounded area, the more ubiquitous the ad.

In an embodiment, scalar numerical weights w₁ and w₂ may be assigned based on experimentation, observation, or other relevant factors, as shown in equation (2).

$$UI ( a ) = {W}_{1} \cdot [ 1 - \{ \frac{Area ( ads )}{\vert Q ( a ) \vert \cdot \vert NSA \vert} \} ] + {W}_{2} \cdot [ 1 - \{ \frac{Area ( search\_results )}{( \vert Q ( a ) \vert \cdot \vert NSW \vert )} \} ] \qquad ( 2 )$$

The numerical weights may be used to give greater authority to certain portions of the equation. For example, generally

$$1 - \{ \frac{Area ( search\_results )}{( \vert Q ( a ) \vert \cdot \vert NSW \vert )} \}$$

will be much smaller than

$$1 - \{ \frac{Area ( ads )}{\vert Q ( a ) \vert \cdot \vert NSA \vert} \} ,$$

and so instead of simply adding the two elements together (as is done in equation (1)), W₂ may be increased in an effort to give similar weight to both elements.

Methods taking into account both ad impressions and click logs also may be used to determine the UI of a sponsored listing. The technique capitalizes on the general observation that ubiquitous ads usually are displayed for a large number of searches, but have a low click-through rate as compared to more relevant ads. Thus, by comparing the click-through rate of an ad to an aggregated click-through rate calculated over all, or a subset of all, ads previously served over some defined period, the ubiquitous nature of an ad may be estimated.

In an embodiment, the UI of an ad may be determined via the following equation:

$$UI ( a ) = 1 - ( \frac{ctr ( a )}{\vert ctr \vert} ) \qquad ( 3 )$$

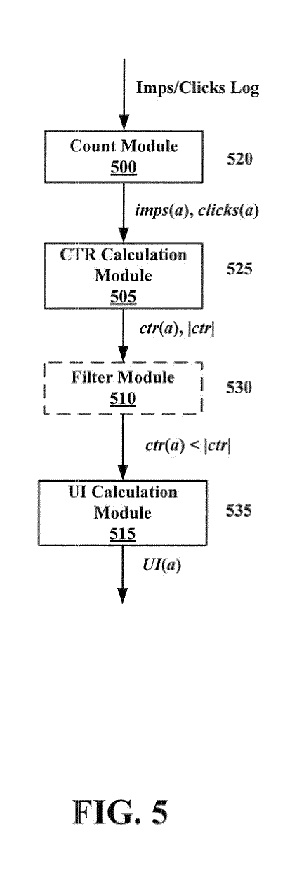

Equation (3) may be implemented as illustrated in FIG. 5. It will be appreciated that each module referenced in the following discussion of FIG. 5 may be implemented in either software or hardware, or some combination thereof, and in practice may be combined with any other module (e.g., each module's operations may be executed by the same machine).

At block 520, imps(a) and clicks(a) may be calculated over time, t, by count module 500, where a refers to a sponsored listing which is displayed for any given query, t refers to a predetermined period of time, imps(a) refers to the number of impressions received by ad a over t, and clicks(a) refers to the number of clicks received by ad a over t. At block 525, ctr(a) may be calculated by click-through rate (CTR) calculation module 505, where ctr(a) refers to the click-through rate of ad a

$$( i . e . , \frac{clicks ( a )}{imps ( a )} )$$

over time t. Next, |ctr| is calculated by CTR calculation module 505, where |ctr| refers to the average click-through rate for all, or a subset of all, ads served over time t. In an embodiment, at block 530 (shown in phantom), ads where ctr(a)>|ctr| may be filtered out by filter module 510, such that only ads where ctr(a)≦|ctr| remain. The ads that may be filtered out at block 530 (i.e., those ads where ctr(a)>|ctr|) generally can be considered to be non-ubiquitous ads, and as such, a UI value for those ads may prove to be unneeded and therefore may not be calculated at all, or simply may be assigned a value of zero. Finally, the UI of ad, a, may be calculated using equation (3) by UI calculation module 515, as illustrated at block 535.

Based upon the foregoing, it will be appreciated that UI values in the examples described may vary in a range from 0.0 to 1.0, where higher values represent increasingly higher likelihoods of ubiquity. Alternative embodiments may be implemented in which the converse is true, depending upon the equations selected for the various computations.

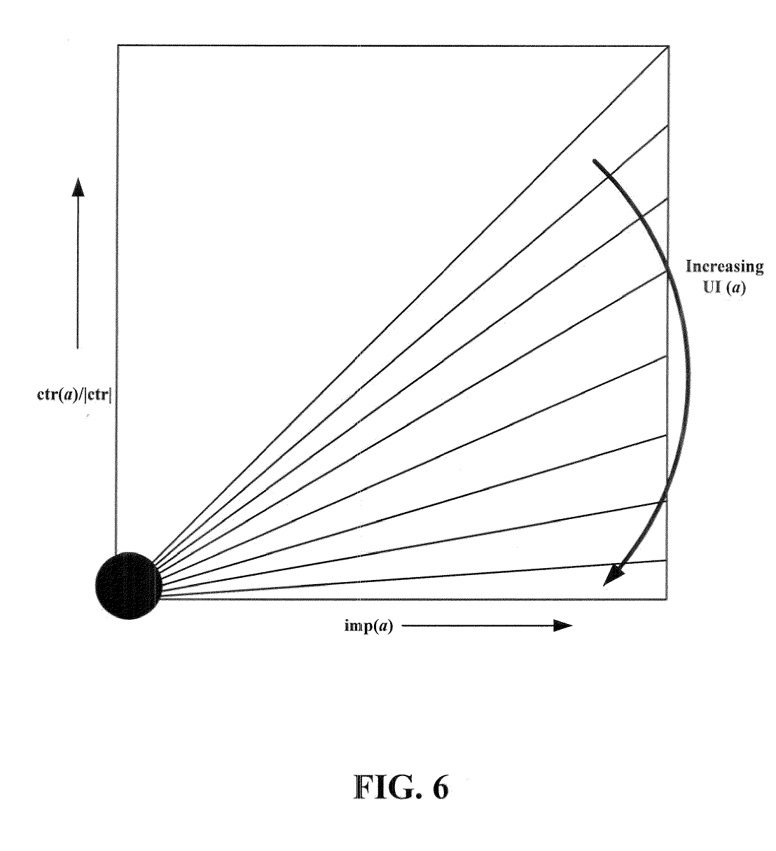

FIG. 6 illustrates generally the correlation between ubiquitous index values and the values of

$$\frac{ctr ( a )}{\vert ctr \vert}$$

and imps(a) according to an embodiment. FIG. 6 assumes that filter module 510 (discussed above) is employed, and as such only ads with a click-through rate equal to or less than the average click-through rate are selected, and so only the area below the diagonal is plotted. The dark circle at the lower left-hand corner indicates that generally only ads which have received a predetermined threshold of impressions should be included in the analysis.

In an embodiment, preliminary UIs of an ad may be determined via two or more methods (such as, for example, equation (1) and equation (2)), and then combined into a final UI to be used by the system. The preliminary UIs may be weighted so as to ensure normalization across the various methods used to generate them.

As discussed, the determination of whether to display an ad may be based, at least partially, on the ad's associated UI. For example, a predetermined threshold may be defined, say 0.7, such that every ad whose UI is above 0.7 may be considered ubiquitous and thus may not be served to a user. It will be appreciated that an ad's UI may be just one of many factors used to determine whether the ad will be served. For example, instead of implementing it as a hard cut-off (as just described), the UI may be used to influence an “overall” score of the ad (e.g., by adding it to or subtracting it from the overall score), which overall score ultimately may determine whether the ad gets displayed. In this scenario, the overall score, as adjusted by the UI, may promote or demote an ad as between other ads available to be displayed, but may not take it out of contention entirely. The overall score may be determined by a combination of factors other than the UI, such as, for example, the relevance of the ad to a particular query, the amount the advertiser is willing to pay to have the ad shown against the query, etc. More generally, the overall score may be associated with the method, algorithm, etc., used to determine which ads to display against the query when UIs are not taken into consideration, or even contemplated by the search infrastructure.

Similarly, an ad's UI may affect its rank on the page. “Rank” or “position” generally denotes the order in which ads are displayed on a web page. For example, if there are four ads displayed together on a page, then an ad's rank may be its position in the group (i.e., the top ad has rank “1,” the second-to-top ad has rank “2,” etc.). Notwithstanding the quality of the advertisements, users tend to click on higher-ranked ads more than lower-ranked ads, and so position can be critical. As an example of how UI scores may affect rank, consider the case where four ads are to be displayed in a vertical arrangement, one above the other, and the UI score is the only factor used to determine rank. In this case, the ad whose UI score is the lowest (i.e., the least ubiquitous ad) may be displayed at the top of the list, the ad whose UI score is the second-lowest may be displayed second from the top, etc. It will be appreciated that UI may be just one of many factors used to affect rank.

Thresholds used to determine whether an ad will be displayed, or what the ad's rank may be, can vary as between submarkets, where submarkets can be defined based on any of a number of known segmentation strategies or methods. For example, a submarket may be assigned to a class or category of queries. When a submarket is defined by a category of queries, say those related to product searches, it may be the case that, for example, the queries result in a large number of available ads, which may appear to be ubiquitous given that, for this particular category, advertisers tend to bid on many related products. In an effort to minimize the effects of this example scenario, the associated UI threshold may be increased. A submarket also may be defined such that it is associated with a particular retailer, product, type of product, the domain or web address of the site that is displaying ads, etc.

The sequence and numbering of blocks depicted in FIGS. 2 and 5 are not intended to imply an order of operations to the exclusion of other possibilities. Those of skill in the art will appreciate that the foregoing systems and methods are susceptible of various modifications and alterations. For example, it may not necessarily be the case that ads are filtered at block 530 of FIG. 5; instead, the UI of every ad served over period, t, may be calculated at block 535.

The various systems described herein may each include a storage component for storing machine-readable instructions for performing the various processes as described and illustrated. The storage component may be any type of machine-readable medium (i.e., one capable of being read by a machine or electronic component) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer-readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of determining whether an advertisement will be served against a search query, said method comprising:
calculating a ubiquitous index of the advertisement, the ubiquitous index associated with a relatedness of a set of search queries against which the advertisement was served over a predetermined period; and
serving the advertisement in accordance with said calculating.

2. The method of claim 1 wherein said serving comprises comparing the ubiquitous index to a predetermined threshold and serving the advertisement responsive to the comparison.

3. The method of claim 1 wherein said calculating comprises solving the following equation for UI(a):
$$UI ( a ) = [ 1 - \{ \frac{Area ( ads )}{\vert Q ( a ) \vert \cdot \vert NSA \vert} \} ] + [ 1 - \{ \frac{Area ( search\_results )}{( \vert Q ( a ) \vert \cdot \vert NSW \vert )} \} ] ,$$
wherein:
a is the advertisement;
Q(a) is the set of queries against which the advertisement was served over the predetermined period;
NSA is a set of advertisements that were served against each query comprising Q(a) over the predetermined period, wherein each element comprising NSA is unique;
NSW is a set of search results that were displayed against each query within Q(a) over the predetermined period, wherein each element comprising NSW is unique;
Area(ads) is a first bounded area on a first two-dimensional graph, where, for each advertisement comprising NSA, a point is plotted based on a frequency with which the respective advertisement was served against the queries comprising Q(a) over the predetermined period; and
Area(search_results) is a second bounded area on a second two-dimensional graph, where, for each search result comprising NSW, a point is plotted based on a frequency with which the respective search result was displayed against the queries comprising Q(a) over the predetermined period.

4. The method of claim 3 wherein a first relative weight of the first bracketed element of the equation with respect to a second relative weight of the second bracketed element is modified by a scalar value.

5. The method of claim 1 further comprising determining, in accordance with the ubiquitous index, a relative rank of the advertisement as among other advertisements to be served therewith.

6. The method of claim 1 wherein the ubiquitous index is further associated with a comparison between a click-through rate associated with the advertisement over the predetermined period and an aggregated click-through rate calculated over a set of advertisements available to be served over the predetermined period.

7. A method of determining whether an advertisement will be served against a search query, said method comprising:
calculating a ubiquitous index of the advertisement in accordance with a comparison between a click-through rate associated with the advertisement over a predetermined period and an aggregated click-through rate calculated over a set of advertisements available to be served over the predetermined period; and
serving the advertisement in accordance with said calculating.

8. The method of claim 7 wherein said serving comprises comparing the ubiquitous index to a predetermined threshold and serving the advertisement responsive to the comparison.

9. The method of claim 7 wherein said calculating comprises solving the following equation for UI(a):
$$UI ( a ) = 1 - ( \frac{ctr ( a )}{\vert ctr \vert} ) ,$$
wherein:
a is the advertisement;
ctr(a) is the click-through rate associated with the advertisement over the predetermined period; and

|ctr| is the average click-through rate of the set of advertisements available to be served over the predetermined period.

10. The method of claim 7 further comprising determining, in accordance with the ubiquitous index, a relative rank of the advertisement as among other advertisements to be served therewith.

11. The method of claim 9 further comprising assigning the ubiquitous index a value of 0 if, during said calculating, it is determined that the click-through rate of the advertisement is greater than the average click-through rate.

12. The method of claim 7 wherein the ubiquitous index is further associated with a relatedness of a set of search queries against which the advertisement was served over the predetermined period.

13. A system for determining whether to serve an advertisement against a search query, said system comprising:
a UI analyzer to:
analyze data associated with the advertisement, wherein the advertisement data is generated over a predetermined period during which the advertisement was available to be served; and
generate a ubiquitous index associated with the advertisement based at least on said analysis; and
a sponsored search module to determine, in accordance with the ubiquitous index, whether the advertisement will be served against the search query.

14. The system of claim 13 wherein the UI analyzer comprises:
a query index module to generate a set of queries for which the advertisement was served against over the predetermined period;
a unique set calculation module to generate:
a set of advertisements, wherein each advertisement in the set of advertisements is unique and was served against a query in the set of queries over the predetermined period; and
a set of search results, wherein each search result in the set of search results is unique and was displayed against a query in the set of queries over the predetermined period; and
a graphing module to calculate:
a first bounded area on a first two-dimensional graph, where, for each advertisement in the set of advertisements, a point is plotted based on a frequency with which the respective advertisement was served against a query in the set of queries over the predetermined period; and
a second bounded area on a second two-dimensional graph, where, for each advertisement in the set of search results, a point is plotted based on a frequency with which the respective search result was displayed against a query in the set of queries over the predetermined period.

15. The system of claim 13 wherein the UI analyzer comprises:
a count module to determine:
a number of impressions received by the advertisement over the predetermined period; and
a number of clicks received by the advertisement over the predetermined period; and
a CTR calculation module to calculate:
the click-through rate of the advertisement; and
the average click-through rate for a set of advertisements that were served over the predetermined period.

16. The system of claim 15 wherein the UI analyzer further comprises a filter module to prevent the ubiquitous index of the advertisement from being generated if the click-through rate of the advertisement is greater than the average click-through rate.

17. A computer-readable medium encoded with a set of instructions which, when performed by a computer, perform a method of determining whether an advertisement will be served against a search query, said method comprising:
calculating a ubiquitous index of the advertisement, the ubiquitous index associated with a relatedness of a set of search queries against which the advertisement was served over a predetermined period; and
serving the advertisement in accordance with said calculating.

18. The computer-readable medium of claim 17 wherein said serving comprises comparing the ubiquitous index to a predetermined threshold and serving the advertisement responsive to the comparison.

19. The computer-readable medium of claim 17 wherein said calculating comprises solving the following equation for UI(a):
$$UI ( a ) = [ 1 - \{ \frac{Area ( ads )}{\vert Q ( a ) \vert \cdot \vert NSA \vert} \} ] + [ 1 - \{ \frac{Area ( search\_results )}{( \vert Q ( a ) \vert \cdot \vert NSW \vert )} \} ] ,$$
wherein:
a is the advertisement;
Q(a) is the set of queries against which the advertisement was served over the predetermined period;
NSA is a set of advertisements that were served against each query comprising Q(a) over the predetermined period, wherein each element comprising NSA is unique;
NSW is a set of search results that were displayed against each query within Q(a) over the predetermined period, wherein each element comprising NSW is unique;
Area(ads) is a first bounded area on a first two-dimensional graph, where, for each advertisement comprising NSA, a point is plotted based on a frequency with which the respective advertisement was served against the queries comprising Q(a) over the predetermined period; and
Area(search_results) is a second bounded area on a second two-dimensional graph, where, for each search result comprising NSW, a point is plotted based on a frequency with which the respective search result was displayed against the queries comprising Q(a) over the predetermined period.

20. The computer-readable medium of claim 19 wherein a first relative weight of the first bracketed element of the equation with respect to a second relative weight of the second bracketed element is modified by a scalar value.

21. The computer-readable medium of claim 17 further comprising determining, in accordance with the ubiquitous index, a relative rank of the advertisement as among other advertisements to be served therewith.

22. The computer-readable medium of claim 17 wherein the ubiquitous index is further associated with a comparison between a click-through rate associated with the advertisement over the predetermined period and an aggregated click-through rate calculated over a set of advertisements available to be served over the predetermined period.

23. A computer-readable medium encoded with a set of instructions which, when performed by a computer, perform a method of determining whether an advertisement will be served against a search query, said method comprising:
calculating a ubiquitous index of the advertisement in accordance with a comparison between a click-through rate associated with the advertisement over a predetermined period and an aggregated click-through rate calculated over a set of advertisements available to be served over the predetermined period; and
serving the advertisement in accordance with said calculating.

24. The computer-readable medium of claim 23 wherein said serving comprises comparing the ubiquitous index to a predetermined threshold and serving the advertisement responsive to the comparison.

25. The computer-readable medium of claim 23 wherein said calculating comprises solving the following equation for UI(a):
$$UI ( a ) = 1 - ( \frac{ctr ( a )}{\vert ctr \vert} ) ,$$
wherein:
a is the advertisement;
ctr(a) is the click-through rate associated with the advertisement over the predetermined period; and

|ctr| is the average click-through rate of the set of advertisements available to be served over the predetermined period.

26. The computer-readable medium of claim 23 further comprising determining, in accordance with the ubiquitous index, a relative rank of the advertisement as among other advertisements to be served therewith.

27. The computer-readable medium of claim 25 further comprising assigning the ubiquitous index a value of 0 if, during said calculating, it is determined that the click-through rate of the advertisement is greater than the average click-through rate.

28. The computer-readable medium of claim 23 wherein the ubiquitous index is further associated with a relatedness of a set of search queries against which the advertisement was served over the predetermined period.
